(19) United States
(12) Patent Application Publication
(10) Pub. No.: US 2023/0031405 A1
(43) Pub. Date: Feb. 2, 2023

(54) INORGANIC TRAPPING AGENT MIXTURES USED IN AN ELECTROCHEMICAL CELL

(71) Applicant: Pacific Industrial Development Corporation, Ann Arbor, MI (US)

(72) Inventors: Shuang Gao, Ann Arbor, MI (US); David Shepard, Canton, MI (US); Yunkui Li, Ann Arbor, MI (US); Ashwin Sankaran, Arnhem (NL)

(21) Appl. No.: 17/789,535

(22) PCT Filed: Dec. 21, 2020
(86) PCT No.: PCT/US2020/066362

§ 371 Date: Jun. 28, 2022

Related U.S. Application Data
(60) Provisional application No. 62/955,510, filed on Dec. 31, 2019.

(51) Int. Cl. H01M 10/0525; H01M 50/451; H01M 50/414; H01M 50/46; H01M 50/446; H01M 4/485; H01M 4/38; H01M 4/583; H01M 10/0568; H01M 50/491

(52) U.S. Cl. CPC H01M 10/0525; H01M 50/451; H01M 50/414; H01M 50/46; H01M 50/446; H01M 4/485; H01M 4/382; H01M 4/386; H01M 4/583; H01M 10/0568; H01M 50/491; H01M 2004/028

(57) ABSTRACT

An electrochemical cell, such as a secondary cell of a lithium-ion battery, that includes a positive electrode with an active material that acts as a cathode; a negative electrode with an active material that acts as an anode; a non-aqueous electrolyte; and a separator placed between the positive electrode and negative electrode. The separator including an inorganic material. This inorganic material includes a mixture of a first inorganic particle and one or more second inorganic particles; wherein the inorganic material absorbs one or more of moisture, free transition metal ions, or hydrogen fluoride (HF) that become present in the electrochemical cell. One or more of the cells may be combined in a housing to form a lithium-ion secondary battery.

### FIELD

This invention generally relates to an inorganic material mixture for use in an electrochemical cell, particularly, a lithium-ion secondary battery. More specifically, this disclosure relates to the use of a mixture of inorganic trapping agents as a protective layer on or as a protective additive incorporated within a separator in an electrochemical cell.

### BACKGROUND

The statements in this section merely provide background information related to the present disclosure and may not constitute prior art.

In operation, an electrochemical cell, such as a secondary cell for a lithium-ion battery, generally includes a negative electrode, a non-aqueous electrolyte, a separator, a positive electrode, and a current collector for each of the electrodes. All of these components are sealed in a case, an enclosure, a pouch, a bag, a cylindrical shell, or the like (generally called the battery's “housing”). Separators usually are polyolefin membranes with micro-meter-size pores, which prevent physical contact the between positive and negative electrodes, while allowing for the transport of ions (e.g., lithium ions) back and forth between the electrodes. A non-aqueous electrolyte, which is a solution of a metal salt, such as a lithium salt, is placed between each electrode and the separator.

Since a polyolefin membrane, such as, for example, polyethylene (PE) and polypropylene (PP), is poorly wet by the non-aqueous electrolyte, the impedance for ion transport increases and results in a poor high-rate capability. More importantly, the polyolefin membrane may be subject to shrinkage at an elevated temperature during the operation of the electrochemical cell (e.g., secondary cell of a lithium-ion battery), thereby, increasing the risk of a short circuit and leading eventually to a possible occurrence of a fire or explosion. Furthermore, the softness of the polyolefin membrane allows for the growth and penetration of dendrites, e.g., lithium dendrites, which adds to the concern for safety. The ability to enhance the wettability of the membrane, reduce the shrinkage of the membrane during operation, and limit or eliminate the potential for a fire or explosion is desirable.

In addition, conventional high-energy, high-rate, and low-cost goals for the construction and use of an electrochemical process, such as that found in secondary lithium-ion batteries, requires that the separator be relatively thin and able to be manufactured at a low cost. One way to make the separator naturally thinner is to incorporate inorganic particles. Several examples of inorganic particles include silica, alumina, magnesium oxide, titanium oxide, zirconium oxide, alumina silicate, calcium silicate, magnesium silicate, calcium carbonate, boehmite, kaolin, zeolite, aluminum hydroxide, magnesium hydroxide, and perovskites. Some of these inorganic particles, like fillers, may assist in strengthening the polymer membrane, preventing heat shrinkage, and improving electrolyte wetting. However, such particles usually are difficult to disperse in order to form uniform membranes. The use of dispersants and cross-link agents may be added to avoid this aggregation issue. However, the use of such dispersants and cross-linking agents will increase the overall manufacturing cost and provide additional safety concerns associated with using the electrochemical cell.

Finally, a variety of other factors may also cause degradation of lithium-ion batteries. Several of these factors include the presence of malicious species in the non-aqueous electrolyte solution. More specifically, lithium-ion secondary batteries may experience degradation in capacity due to prolonged exposure to moisture (e.g., water), hydrogen fluoride (HF), and/or dissolved transition-metal ions (TMⁿ⁺). These malicious species may arise as a residue resulting from the fabrication process used to construct the battery or as a decomposition product of the organic electrolyte used therein. In fact, the lifetime of a lithium-ion secondary battery can become severely limited once 20% or more of the original reversible capacity is lost or becomes irreversible. The ability to prolong the rechargeable capacity and overall lifetime of lithium-ion secondary batteries can decrease the cost of replacement and reduce the environmental risks for disposal and recycling.

### DESCRIPTION OF THE DRAWINGS

In order that the disclosure may be well understood, there will now be described various forms thereof, given by way of example, reference being made to the accompanying drawings. The components in each of the drawings may not necessarily be drawn to scale, but rather emphasis is placed upon illustrating the principles of the invention.

FIG. 1A is a schematic representation of an electrochemical cell formed according to the teachings of the present disclosure in which an inorganic material is applied to the separator.

FIG. 1B is a schematic representation of the electrochemical cell of FIG. 1A shown as a lithium-ion secondary cell formed according to the teachings of the present disclosure in which an inorganic material is applied to the separator.

FIG. 2 is a schematic representation of the inorganic material comprising a random dispersion of first inorganic particles and second inorganic particles.

FIG. 3A is a schematic representation of a lithium-ion secondary battery formed according to the teachings of the present disclosure showing the layering of four secondary cells including two of the secondary cells of FIG. 1B to form a larger mixed cell.

FIG. 3B is a schematic representation of a lithium-ion secondary battery formed according to the teachings of the present disclosure showing the incorporaiton of four secondary cells including two of the secondary cells of FIG. 1B in series.

FIG. 4A is a schematic representation of another lithium-ion secondary battery showing the layering of four secondary cells including four of the secondary cells of FIG. 1B to form a larger mixed cell.

FIG. 4B is a schematic representation of another lithium-ion secondary battery formed according to the teachings of the present disclosure showing the incorporaiton of four secondary cells including four of the secondary cells of FIG. 1B in series.

The drawings described herein are for illustration purposes only and are not intended to limit the scope of the present disclosure in any way.

### DETAILED DESCRIPTION

The following description is merely exemplary in nature and is in no way intended to limit the present disclosure or its application or uses. For example, the inorganic materials made and used according to the teachings contained herein is described throughout the present disclosure in conjunction with a secondary cell for use in a lithium-ion secondary battery in order to more fully illustrate the structural elements and the use thereof. The incorporation and use of such inorganic materials in other applications, including without limitation an electrochemical cell or in a primary cell used in a lithium-ion battery is contemplated to be within the scope of the present disclosure. It should be understood that throughout the description and drawings, corresponding reference numerals indicate like or corresponding parts and features.

The main difference between a lithium-ion battery and a lithium ion secondary battery is that the lithium battery represents a battery that includes a primary cell and a lithium-ion secondary battery represents a battery that includes a secondary cell. The term “primary cell” refers to a battery cell that is not easily or safely rechargeable, while the term “secondary cell” refers to a battery cell that may be recharged. As used herein a “cell” refers to the basic electrochemical unit of a battery that contains the electrodes, separator, and electrolyte. In comparison, a “battery” refers to a collection of cell(s), e.g., one or more cells, and includes a housing, electrical connections, and possibly electronics for control and protection.

Since lithium-ion (e.g., primary cell) batteries are not rechargeable, their current shelf life is about three years, after that, they are worthless. Even with such a limited lifetime, lithium batteries can offer more in the way of capacity than lithium-ion secondary batteries. Lithium-ion batteries use lithium metal as the anode of the battery unlike lithium ion secondary batteries that can use a number of other materials to form the anode. One key advantage of lithium-ion secondary cell batteries is that they are rechargeable several times before becoming ineffective. The ability of a lithium-ion secondary battery to undergo the charge-discharge cycle multiple times arises from the reversibility of the redox reactions that take place. Lithium-ion secondary batteries, because of the high energy density, are widely applied as the energy sources in many portable electronic devices (e.g., cell phones, laptop computers, etc.), power tools, electric vehicles, and grid energy storage.

For the purpose of this disclosure, the terms “about” and “substantially” are used herein with respect to measurable values and ranges due to expected variations known to those skilled in the art (e.g., limitations and variability in measurements).

For the purpose of this disclosure, the terms “at least one” and “one or more of” an element are used interchangeably and may have the same meaning. These terms, which refer to the inclusion of a single element or a plurality of the elements, may also be represented by the suffix “(s)” at the end of the element. For example, “at least one metal”, “one or more metals”, and “metal(s)” may be used interchangeably and are intended to have the same meaning.

The present disclosure generally provides a separator that includes an inorganic material that comprises, consists essentially of, or consists of a mixture of a first inorganic particle and one or more second inorganic particles, such that the inorganic material absorbs one or more of moisture (H₂O), free transition metal ions (TMⁿ⁺), or hydrogen fluoride (HF) that become present in the electrochemical cell. The inorganic material acts as a trapping agent or scavenger for the malicious species present within the housing of the battery. The inorganic material accomplishes this objective by effectively absorbing moisture, free transition-metal ions, and/or hydrogen fluoride (HF) selectively, while having no effect on the performance of the non-aqueous electrolyte, including the lithium-ions and organic transport medium contained therein.

Moisture present in an electrochemical cell, such as a secondary Li-ion battery, mainly arises as residue from the fabrication of cell and/or as a decomposition product of the organic electrolyte. Even though manufacturing operations may “dry” the environment during assembly, it is nearly impossible to remove moisture thoroughly during the production of a battery. In addition, the organic electrolyte solvent, especially when operated at an elevated temperature, is inclined to decompose to yield CO₂ and H₂O by-products. The present of H₂O in a Li-ion battery can react with the Li salt (e.g., LiPF₆) present in the electrolyte to generate LiF and HF. The LiF that is formed may deposit on the surfaces of the active materials associated with one or more of the electrodes thereby, forming a solid electrolyte interface (SEI), which can retard the Li-ions (de)intercalation, inactivate the surface of active materials, and lead to a poor rate capability and/or capacity loss.

Furthermore, the HF that is formed may attack the positive electrode, which contains transition metal and oxygen ions, creating more H₂O and transition metal-containing compounds other than the active material. The use of water as a reactant links the reactions cyclically, accelerating the damage to the electrolyte and the active material. The transition metal-containing compounds that are formed may be insoluble in the electrolyte, as well as electrochemically inactive. The insoluble transition-metal compounds may become deposited onto the surface of the positive electrode forming a SEI. Alternatively, if the transition metal-containing ions are soluble, they may dissolve into the organic electrolyte in ionic form. These free ions, for example, Mn²⁺ and Ni²⁺, may be attracted to the negative electrode, wherein they may form a part of a SEI and initiate a variety of succeeding reactions. Thus, the presence of HF in the electrochemical ultimately consumes the active materials and the Li ions present in the electrolyte continuously, thereby, reducing the capacity associated with the lithium-ion battery.

In addition, the inorganic material of the present disclosure incorporated with the separator (e.g., polymeric membrane) either as an additive within the separator or as a coating applied to the surface of the separator may act as fillers for the polymeric membrane or in the applied protective coating layer. Thus, the inorganic material may strengthen the polymer membrane, prevent heating shrinkage, and improve electrolyte wetting. The inorganic material may also be capable of mitigating dendrite formation and retarding the potential occurrence of a fire or explosion.

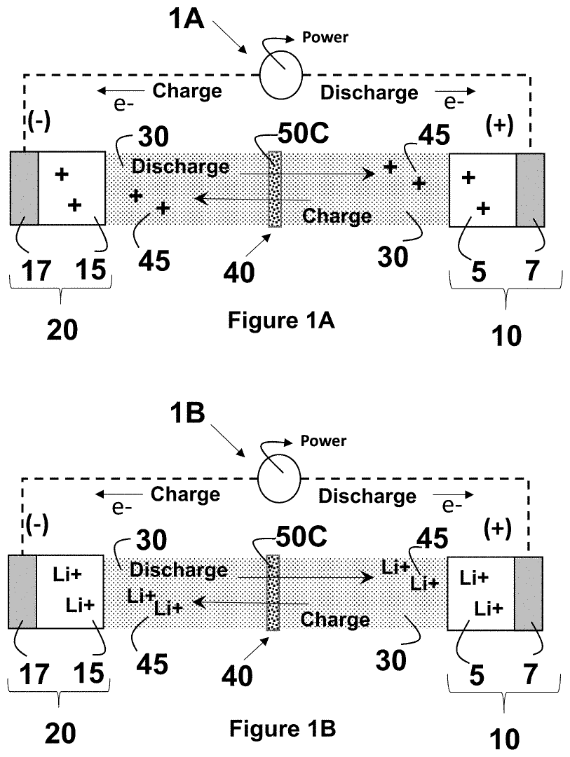

Referring to FIG. 1A, an electrochemical cell 1A generally comprises a positive electrode 10, a negative electrode 20, a non-aqueous electrolyte 30, and a separator 40. The positive electrode 10 comprises an active material that acts as a cathode 5 for the cell 1 and a current collector 7 that is in contact with the cathode 5, such that ions 45 flow from the cathode 5 to the anode 15 when the cell 1 is charging. Similarly, the negative electrode 20 comprises an active material that acts as an anode 15 for the cell 1 and a current collector 17 that is in contact with the anode 15, such that ions 45 flow from the anode 15 to the cathode 5 when the cell 1 is discharging. The contact between the cathode 5 and the current collector 7, as well as the contact between the anode 15 and the current collector 17, may be independently selected to be direct or indirect contact; alternatively, the contact between the anode 15 or cathode 5 and the corresponding current collector 17, 7 is directly made.

Referring now to FIG. 1B, the electrochemical cell 1A of FIG. 1A is shown as a secondary cell 1B for use in a lithium-ion secondary battery. In this specific application, the ions 45 that reversibly flow between the anode 15 and the cathode 5 are lithium ions (Li⁺).

Referring now to both FIGS. 1A and 1B, the non-aqueous electrolyte 30 is positioned between and in contact with, i.e., in fluid communication with, both the negative electrode 20 and the positive electrode 10. This non-aqueous electrolyte 30 supports the reversible flow of ions 45 (e.g., Lithium-ions) between the positive electrode 10 and the negative electrode 20. The separator 40, which comprises a polymeric membrane, is placed between the positive electrode 10 and negative electrode 20, such that the separator 40 separates the anode 15 and a portion of the electrolyte 30 from the cathode 5 and the remaining portion of the electrolyte 30. The separator 40 is permeable to the reversible flow of the ions 45 there through.

Still referring to FIGS. 1A and 1B, the inorganic material 50C is included as part of the separator 40. The inorganic material 50C may be incorporated with the separator (e.g., polymeric membrane) either as an additive within the separator or as a coating applied to the surface of the separator. Alternatively, the inorganic material may be applied to one-side of the separator 40 or to both-sides of the separator 40. This inorganic material 50C is selected to be a mixture of a first inorganic particle and one or more second inorganic particles; wherein the inorganic material absorbs one or more of moisture, free transition metal ions, or hydrogen fluoride (HF) that become present in the electrochemical cell. The amount of the inorganic material 50C present in the cell 1A, 1B may be up to 100 wt. %; alternatively, up to 50 wt. %; alternatively, between 1 wt. % and 50 wt. %, relative to the overall weight of the separator. The weight ratio of the first inorganic particle to the one or more second inorganic particles is in the range of 0.05 wt. % to about 85.0 wt. %; alternatively, 0.1 wt. % to about 75.0 wt. %; alternatively, 1.0 wt. % to about 65.0 wt. %; alternatively, 5.0 wt. % to 50.0 wt. % based on the overall weight of the inorganic material.

The first inorganic particle may comprise lithium (Li)—exchanged zeolite. The first inorganic particles exhibit a morphology that is either platelet, cubic, or sphere and has an average particle size (D₅₀) in the range of 0.01 micrometers (μm) to about 2 μm; alternatively, between about 0.1 μm and about 1.75 μm; alternatively, between about 0.2 μm and 1.5 μm. The first inorganic particles may also exhibit a surface area of 5 m²/g to about 1,250 m²/g; alternatively, 10 m²/g to 1,000 m²/g; alternatively, about 50 m²/g to about 800 m²/g. The pore volume exhibited by the first inorganic particles is on the order of about 0.05 cc/g to about 2.5 cc/g; alternatively, 0.1 cc/g to about 2.0 cc/g; alternatively, about 0.3 cc/g to about 1.5 cc/g.

The framework of the Li-ion exchanged zeolites used as the first inorganic particle may be chosen from, but not limited to, ABW, AFG, BEA, BHP, CAS, CHA, CHI, DAC, DOH, EDI, ESV, FAU, FER, FRA, GIS, GOO, GON, HEU, KFI, LAU, LTA, LTN, MEI, MER, MOR, MSO, NAT, NES, PAR, PAU, PHI, RHO, RTE, SOD, STI, TER, THO, VET, YUG, and ZSM. The ratio of SiO₂/Al₂O₃ in the zeolite ranges from 1 to 100; alternatively, 2 to about 90; alternatively, about 4 to about 80. The concentration of sodium (Na) in the zeolite is initially in the range of 0.1 to 20 wt. % based on the overall weight of the zeolite. However, lithium ions will replace some or most of the sodium ions in the framework via an ion exchange process. The final sodium (Na) concentration in the first inorganic particles after undergoing such exchange with lithium ions is lower than 10 wt. %; alternatively, less than 8 wt. %, alternatively, between 0.01 wt. % and 10 wt. % based on the overall weight of the zeolite.

Zeolites are crystalline or quasi-crystalline aluminosilicates comprised of repeating TO₄ units with T being most commonly silicon (Si) or aluminum (Al). These repeating units are linked together to form a crystalline framework or structure that includes cavities and/or channels of molecular dimensions within the crystalline structure. Thus, aluminosilicate zeolites comprise at least oxygen (O), aluminum (Al), and silicon (Si) as atoms incorporated in the framework structure thereof. Since zeolites exhibit a crystalline framework of silica (SiO₂) and alumina (Al₂O₃) interconnected via the sharing of oxygen atoms, they may be characterized by the ratio of SiO₂:Al₂O₃ (SAR) present in the crystalline framework.

The framework notation represents a code specified by the International Zeolite Associate (IZA) that defines the framework structure of the zeolite. Thus, for example, a chabazite means a zeolite in which the primary crystalline phase of the zeolite is “CHA”. The crystalline phase or framework structure of a zeolite may be characterized by X-ray diffraction (XRD) data. However, the XRD measurement may be influenced by a variety of factors, such as the growth direction of the zeolite; the ratio of constituent elements; the presence of an adsorbed substance, defect, or the like; and deviation in the intensity ratio or positioning of each peak in the XRD spectrum. Therefore, a deviation of 10% or less; alternatively, 5% or less; alternatively, 1% or less in the numerical value measured for each parameter of the framework structure for each zeolite as described in the definition provided by the IZA is within expected tolerance.

According to one aspect of the present disclosure, the zeolites of the present disclosure may include natural zeolites, synthetic zeolites, or a mixture thereof. Alternatively, the zeolites are synthetic zeolites because such zeolites exhibit greater uniformity with respect to SAR, crystallite size, and crystallite morphology, as well has fewer and less concentrated impurities (e.g. alkaline earth metals).

The one or more second inorganic particles are independently selected from the group consisting of silica, α-alumina, β-alumina, γ-alumina, magnesium oxide, titanium oxide, zirconium oxide, alumina silicate, calcium silicate, magnesium silicate, calcium carbonate, boehmite, kaolin, aluminum hydroxide, magnesium hydroxide, and perovskites. Alternatively, the one or more second inorganic particles are selected as α-alumina, β-alumina, γ-alumina, boehmite, or aluminum hydroxide.

The one or more second inorganic particles exhibit a morphology that is either platelet, cubic, or sphere and has an average particle size (D₅₀) in the range of 0.01 micrometers (μm) to about 2 μm; alternatively, between about 0.1 μm and about 1.75 μm; alternatively, between about 0.2 μm and 1.5 μm. The first inorganic particles may also exhibit a surface area of 5 m²/g to about 1,250 m²/g; alternatively, 10 m²/g to 1,000 m²/g; alternatively, about 50 m²/g to about 800 m²/g. The pore volume exhibited by the first inorganic particles is on the order of about 0.05 cc/g to about 2.5 cc/g; alternatively, 0.1 cc/g to about 2.0 cc/g; alternatively, about 0.3 cc/g to about 1.5 cc/g. The concentration of sodium (Na) in the one or more second inorganic particles is in the range of 0.01 wt. % to 0.3 wt. %; alternatively, between about 0.05 wt. % and 0.25 wt. % based on the overall weight of the zeolite.

Scanning electron microscopy (SEM) or other optical or digital imaging methodology known in the art may be used to determine the shape and/or morphology of the inorganic material. The average particle size and particle size distributions may be measured using any conventional technique, such as sieving, microscopy, Coulter counting, dynamic light scattering, or particle imaging analysis, to name a few. Alternatively, a laser particle analyzer is used for the determination of average particle size and its corresponding particle size distribution. The measurement of surface area and pore volume for the inorganic material may be accomplished using any known technique, including without limitation, microscopy, small angle x-ray scattering, mercury porosimetry, and Brunauer, Emmett, and Teller (BET) analysis. Alternatively, the surface area and pore volume is determined using Brunauer, Emmett, and Teller (BET) analysis.

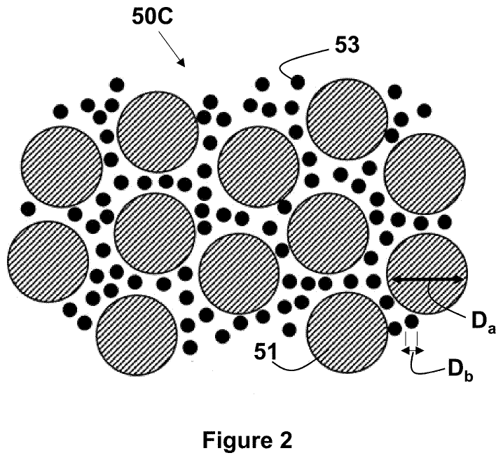

Referring now to FIG. 2, the inorganic material 50C may be described as comprising particles A 51 and particles B 53 that are randomly dispersed with one another (see FIG. 2). In this core-shell composite 57, particles A 51 represent the core and particles B 53 are adhered to the surface of the core as the shell. The particles B 53 exhibit an average diameter (D_{b}) and the particles A 51 exhibit an average diameter (Dₐ), such that Dₐ is larger than D_{b}. When desirable, Dₐ may be at least two (2) times greater than D_{b}; alternatively, Dₐ is three (3) or more times greater than D_{b}; alternatively, Dₐ is at least five (5) times greater than D_{b}. The average diameters of Dₐ and D_{b} are generally D₁₀; alternatively, D₅₀, alternatively, D₉₀. Generally, the first inorganic particle is utilized as particles A 51, while the one or more second inorganic particles are particles B 53. However, when desirable, the one or more inorganic particles may be utilized as particles A 51, while the first inorganic particles are particles B 53.

The inorganic material 50C may be fabricated by mechanical milling. This mechanical milling may be accomplished using any type of conventional mill, including but not limited to a ball mill, a jet mill, an Eiger mill, an attritor mill, or a vibratory mill. The surface properties of the particles A and B may be modified by the addition of dispersants, surfactants, coupling agents, or the like as desired or necessary prior to or during the milling process.

When the inorganic material 50C is applied as a coating, the coating formulation may also comprise an organic binder 59, such that the inorganic material accounts for about 10 wt. % to 99 wt. %; alternatively from about 15 wt. % to 95 wt. % of the overall weight of the coating. This organic binder may include, but not be limited to polyvinyl alcohol (PVA), polyethylene oxide (PEO), polyvinylpyrrolidone (PVP), polypropylene oxide (PPO), polyacrylic acid (PAA), carboxymethyl cellulose (CMC), sodium ammonium alginate (SAA), or a mixture thereof.

Referring once again to FIGS. 1A and 1B, the active materials in the positive electrode 10 and the negative electrode 20 may be any material known to perform this function in an electrochemical cell, e.g., in a secondary cell of a lithium-ion battery. The active material used in the positive electrode 10 may include, but not be limited to lithium transition metal oxides or transition metal phosphates. Several examples of active materials that may be used in the positive electrode 10 include, without limitation, LiCoO₂, LiNi_{1-x-y}CoₓMn_{y}O₂ (x+y≤⅔), zLi₂MnO₃.(1-z)LiNi_{1-x-y}CoₓMn_{y}O₂ (x+y≤⅔), LiMn₂O₄, LiNi_{0.5}Mn_{1.5}O₄, and LiFePO₄. The active materials used in the negative electrode 15 may include, but not be limited to graphite and Li₄Ti₅O₁₂, as well as silicon and lithium metal. Alternatively, the active material for use in the negative electrode is silicon or lithium metal due to their one-magnitude higher specific capacities. The current collectors 7, 17 in both the positive 10 and negative 20 electrodes may be made of any metal known in the art for use in an electrode of an electrochemical cell or lithium battery, such as for example, aluminum for the cathode and copper for the anode. The cathode 5 and anode 15 in the positive 10 and negative 20 electrodes are generally made up of two dissimilar active materials.

The non-aqueous electrolyte 30 is selected, such that it supports the oxidation/reduction process and provides a medium for ions 45 (e.g., lithium-ions) to flow between the anode 15 and cathode 5. The non-aqueous electrolyte 30 may be a solution of an inorganic salt in an organic solvent. Several specific examples of lithium salts used in the secondary cell of a lithium battery, include, without limitation, lithium hexafluorophosphate (LiPF₆), lithium bis(oxalato)-borate (LiBOB), and lithium bis(trifluoro methane sulfonyl)imide (LiTFSi). The inorganic salts may form a solution with an organic solvent, such as, for example, ethylene carbonate (EC), ethyl methyl carbonate (EMC), diethyl carbonate (DEC), dimethyl carbonate (DMC), propylene carbonate (PC), vinylene carbonate (VC), and fluoroethylene carbonate (FEC), to name a few. A specific example of an electrolyte for use in a secondary cell of a lithium battery is a 1 molar solution of LiPF₆ in a mixture of ethylene carbonate and diethyl carbonate (EC/DEC=50/50 vol.).

Still referring to FIGS. 1A and 1B, the separator 40 ensures that the anode 15 and cathode 5 do not touch and allows ions 45 to flow there through. The separator 40 may be a polymeric membrane comprising, without limitation, polyolefin-based materials with semi-crystalline structure, such as polyethylene, polypropylene, and blends thereof, as well as micro-porous poly(methyl methacrylate)-grafted, siloxane grafted polyethylene, and polyvinylidene fluoride (PVDF) nanofiber webs. Alternatively, the polymeric membrane is polyolefin, such as polyethylene, polypropylene, or a blend thereof.

A separator 40 plays a significant role in the safety, durability, and high-rate performance of an electrochemical cell, such as a secondary cell for a lithium-ion battery. A polymeric membrane is electrically insulating and separates the positive and negative electrodes completely to avoid an internal short circuit. The polymeric membrane usually is not ionically conductive, but rather has large pores filled with the non-aqueous electrolyte, allowing for the transport of ions.

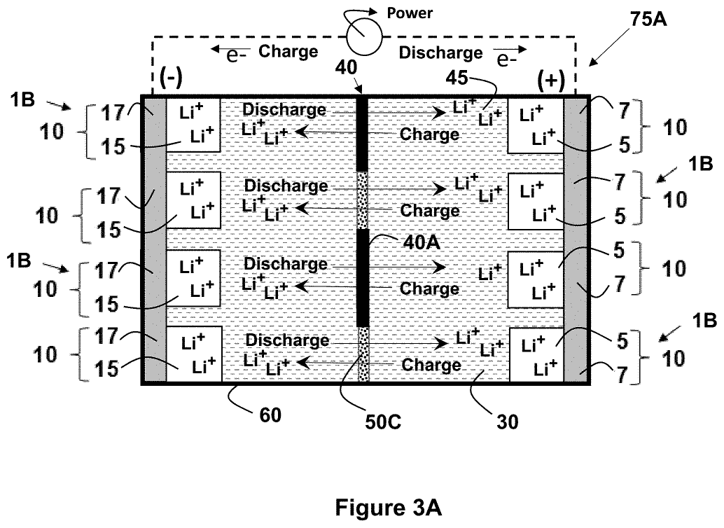

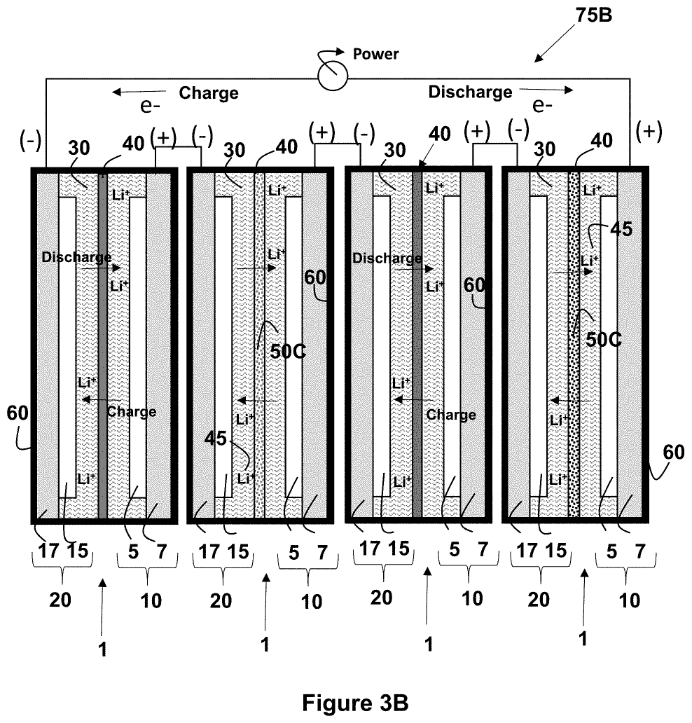

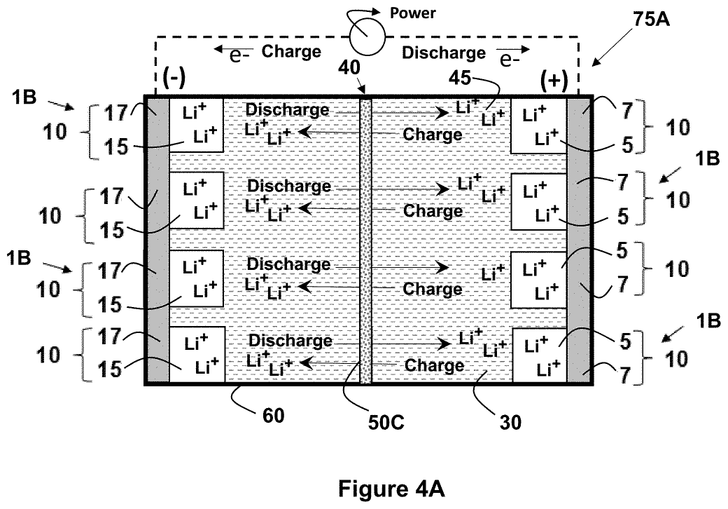

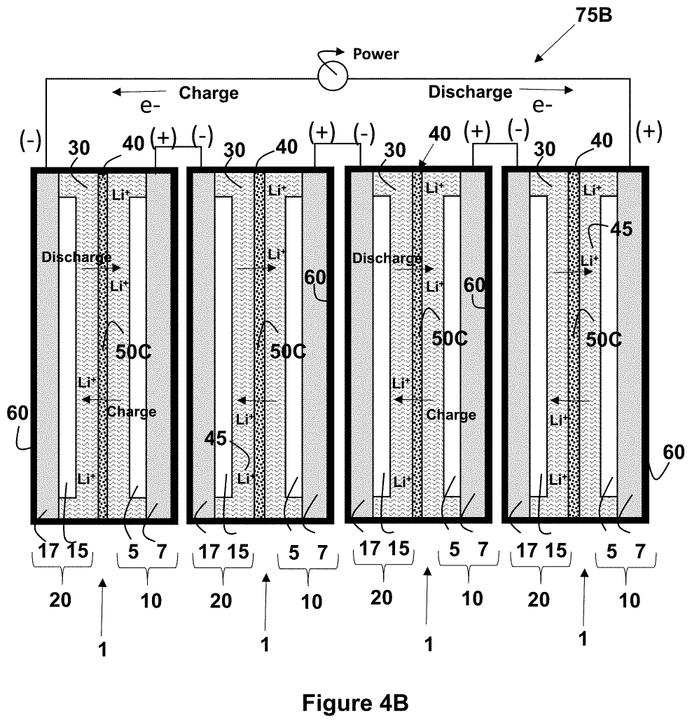

According to one aspect of the present disclosure, one or more secondary cells may be combined to form an electrochemical cell, such as a lithium-ion secondary battery. In FIGS. 3A and 4A, an example of such a battery 75A is shown in which four (4) secondary cells 1 are layered to form a larger single secondary cell that is encapsulated to produce the lithium-ion secondary battery 75A. In FIGS. 3B and 4B, another example of a battery 75B is shown, in which four (4) secondary cells are stacked or placed in series to form a larger capacity battery 75B with each cell being individually contained.

Referring specifically to FIGS. 3A, 3B, 4A, and 4B, an example of such a battery 75A, 75B is shown in which the two (2) secondary cells of FIG. 1B (see FIGS. 3A, 3B) and four (4) secondary cells of FIG. 1B (see FIGS. 4A, 4B) are combined to form the corresponding battery 75A, 75B. The lithium-ion secondary battery 75A, 75B also includes a housing 60 having an internal wall in which the secondary cells 1 are enclosed or encapsulated in order to provide for both physical and environmental protection. One skilled in the art will understand that although the battery 75A, 75B shown in FIGS. 3A or 3B and in FIGS. 4A or 4B incorporates two secondary cells and four secondary cells of FIG. 1B, respectively, that such a battery 75A, 75B may include any other number of secondary cells.

One skilled in the art will also appreciate that although FIGS. 3A-4B demonstrate the incorporation of secondary cells 1B into a lithium-ion secondary battery 75A, 75B, the same principles may be used to encompass or encase one or more electrochemical cells 1A into a housing 60 for use in another application. In these electrochemical cells 1A, the inorganic material 50C may be dispersed within at least a portion of the separator 40 or in the form of a coating applied onto a portion of a surface of the separator 40.

The housing 60 may be constructed of any material known for such use in the art and be of any desired geometry required or desired for a specific application. For example, lithium-ion batteries generally are housed in three different main form factors or geometries, namely, cylindrical, prismatic, or soft pouch. The housing 60 for a cylindrical battery may be made of aluminum, steel, or the like. Prismatic batteries generally comprise a housing 60 that is rectangular shaped rather than cylindrical. Soft pouch housings 60 may be made in a variety of shapes and sizes. These soft housings may be comprised of an aluminum foil pouch coated with a plastic on the inside, outside, or both. The soft housing 60 may also be a polymeric-type encasing. The polymer composition used for the housing 60 may be any known polymeric materials that are conventionally used in lithium-ion secondary batteries. One specific example, among many, include the use of a laminate pouch that comprises a polyolefin layer on the inside and a polyamide layer on the outside. A soft housing 60 needs to be designed such that the housing 60 provides mechanical protection for the secondary cells 1B present in the battery 75.

The specific examples provided in this disclosure are given to illustrate various embodiments of the invention and should not be construed to limit the scope of the disclosure. The embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

Evaluation Method 1—Transition-Metal Cations Trapping Capability of the Inorganic Additive

The performance of the inorganic additive with respect to adsorption capabilities for Mn²⁺, Ni²⁺, and Co²⁺, are measured in an organic solvent, namely a mixture of ethylene carbonate and dimethyl carbonate (EC/DMC=50/50 vol.)

The Mn²⁺, Ni²⁺, and Co²⁺ trapping capabilities of the inorganic additives in the organic solvent are analyzed by inductively coupled plasma—optical emission spectrometry (ICP-OES). The organic solvent is prepared, such that it contains 1000 ppm manganese (II), nickel (II), and cobalt (II) perchlorate, respectively. The inorganic additive in particle form is added as 1 wt. % of the total mass, with the mixture being stirred for 1 minute. The mixture is then allowed to stand still at 25° C. for 24 hours prior to measuring the decrease of the concentration of Mn²⁺, Ni²⁺, and Co²⁺.

Evaluation Method 2—HF Scavenging Capability of the Inorganic Additive

The HF scavenging capability of the inorganic additives in the non-aqueous electrolyte, namely 1 M LiPF₆ in a mixture of ethylene carbonate and dimethyl carbonate (EC/DMC=50/50 vol.), is analyzed by a Fluoride ion specific (ISE) meter. The electrolyte solution is prepared, such that it contains 100 ppm HF. The inorganic additive in particle form is added as 1 wt. % of the total mass, with the mixture being stirred for 1 minute. The mixture is then allowed to stand still at 25° C. for 24 hours prior to measuring the decrease of F⁻ in the solution.

Below are the reactions that occur in a Li-ion battery with moisture residue.

LiPF₆+H₂O→HF+LiF↓+H₃PO₄

LiMO₂+HF→LiF↓+M²⁺+H₂O,

wherein M stands for transition metal.

As a result, in order to reduce HF in the electrolyte, the inorganic additive needs to consume HF and moisture residue at the same time to break the reaction chain.

Evaluation Method 3—Separator Coating

The separators are fabricated using a monolayer polypropylene membrane (Celgard® 2500, Celgard LLC, North Carolina). Separators with and without the inclusion of the inorganic additive are constructed for performance comparison. A slurry containing the inorganic additive is coated onto the separator in two-side form. The slurry is made of 10-50 wt. % inorganic additive particles dispersed in deionized (D.I.) water. The mass ratio of a polymeric binder to the total solids is 1-10%. The coating is applied with 5-15 μm in thickness before drying. The thickness of the coated separator is 25-45 μm. The coated separators are punched into a round disks in a diameter of 19 mm.

Evaluation Method 4—Coin-Cell Cycling

Coin cells (2025-type) are made for evaluating the inorganic additives in an electrochemical situation. A coin cell is made with exterior casing, spacer, spring, current collector, positive electrode, separator, negative electrode, and non-aqueous electrolyte.

To fabricate films for use with the positive electrode, a slurry is made by dispersing the active material (AM), such as LiNi_{0.8}Co_{0.1}Mn_{0.1}O₂ and carbon black (CB) powders in an n-methyl-2-pyrrolidone (NMP) solution of polyvinylidene fluoride (PVDF). The mass ratio of AM:CB:PVDF slurry is 90:5:5. In each case, the slurry is blade coated onto aluminum films. After drying and calendaring, the thickness of each positive electrode film formed is measured to be in the range of 50-150 μm. The positive electrode films are punched into round disks with a diameter of 12 mm respectively. The typical mass loading of active material is around 6 mg/cm².

Lithium metal foil (0.75 mm in thickness) is cut into a round disk in a diameter of 12 mm for use as the negative electrode.

Coin cells (2025-type) are made along with the above mentioned positive and negative electrodes, separator as described in Evaluation Method 3, and 1 M LiPF₆ in a mixture of ethylene carbonate and dimethyl carbonate (EC/DMC=50/50 vol.) as the electrolyte as further described herein for battery performance testing. The cells are cycled between 3 and 4.3 V at the current loadings of C/3 at 25° C. after two C/10 formation cycles.

### EXAMPLE 1

A FAU-type Y zeolite is used as the inorganic additive, which has been ion-exchanged with lithium (Li). The particle size is measured as 0.27, 0.43, and 3.76 μm for D₁₀, D₅₀, and D₉₀, respectively. The surface area is 640 m²/g with the pore volume of 0.23 cc/g. The ratio of silica:alumina (SAR) is 3.6, and the inorganic additive contains 0.35 wt. % of Na₂O and 6.36 wt. % of Li₂O.

In the trapping capability test for transition-metal cations, the inorganic additive reduced the Ni²⁺, Mn²⁺, and Co²⁺ in EC/DMC by 63%, 77%, and 84%, respectively. In addition, the inorganic additive scavenges 30% HF in the electrolyte solution.

### EXAMPLE 2

A type of γ-Al₂O₃ is used as the inorganic additive. The particle size is measured as 2.3, 3.3, and 5.2 μm for D₁₀, D₅₀, and D₉₀, respectively. The surface area is 155.3 m²/g with a pore volume of 0.60 cc/g. Loss on ignition (LOI) testing of this γ-Al₂O₃ demonstrates that it contains 83.05 wt. % of Al₂O₃.

This γ-Al₂O₃ does not show the trapping capability in terms of Ni²⁺, Mn²⁺, and Co²⁺ in EC/DMC. However, it scavenges 23% HF in the electrolyte solution.

### EXAMPLE 3

A type of boehmite is used as the inorganic additive. The particle size is measured as 9.3, 30.2, and 53.4 nm for D₁₀, D₅₀, and D₉₀, respectively. The surface area is 100.2 m²/g with a pore volume of 0.48 cc/g. The boehmite contains 83.05 wt. % of Al₂O₃.

This boehmite does not show the trapping capability in terms of Ni²⁺, Mn²⁺, and Co²⁺ in EC/DMC. However, it scavenges 10% HF in the electrolyte solution.

### EXAMPLE 4

A bare polypropylene membrane is used as the separator for cycling test as described in evaluation method 4. The thickness of the membrane is 25 μm. The cell exhibits a 3.5% loss of capacity and 2.5% loss of coulombic efficiency in 70 cycles.

### EXAMPLE 5

A mixture comprising Examples 1 and 2 is coated on a piece of a polypropylene separator in a double-side form. In the coating layer, the weight ratio of [Example 1]:[Example 2]:PVA is 5:45:10. The thickness of the coated separator is 39.0 μm.

The mixture coated polypropylene film is used as the separator for cycling test as described in evaluation method 4. The cell exhibits a 1.5% loss of capacity and an almost zero loss of coulombic efficiency in 70 cycles.

### EXAMPLE 6

A mixture comprising Examples 1 and 3 is coated on a piece of bare polypropylene separator in a double-side form. In the coating layer, the weight ratio of [Example 1]:[Example 3]:PVA is 5:45:10. The thickness of the coated separator is 38.8 μm.

The mixture coated polypropylene film is used as the separator for cycling test as described in evaluation method 4. The cell exhibits a 1.5% loss of capacity and an almost zero loss of coulombic efficiency in 70 cycles.

### EXAMPLE 7

A mixture comprising Examples 1 and 2 is coated on a piece of a polypropylene separator in a double-side form. In the coating layer, the weight ratio of [Example 1]:[Example 2]:PVA is 25:25:10. The thickness of the coated separator is 42.0 μm.

The mixture coated polypropylene film is used as the separator for cycling test as described in evaluation method 4. The cell exhibits a 1.5% loss of capacity and an almost zero loss of coulombic efficiency in 70 cycles.

Upon comparing with the cell with bare polypropylene, the cells with a mixture coated separator are found to have a higher capacity retention and less degradation of coulombic efficiency during long-term cycling.

Those skilled-in-the-art, in light of the present disclosure, will appreciate that many changes can be made in the specific embodiments which are disclosed herein and still obtain alike or similar result without departing from or exceeding the spirit or scope of the disclosure. One skilled in the art will further understand that any properties reported herein represent properties that are routinely measured and can be obtained by multiple different methods. The methods described herein represent one such method and other methods may be utilized without exceeding the scope of the present disclosure.

The foregoing description of various forms of the invention has been presented for purposes of illustration and description. It is not intended to be exhaustive or to limit the invention to the precise forms disclosed. Numerous modifications or variations are possible in light of the above teachings. The forms discussed were chosen and described to provide the best illustration of the principles of the invention and its practical application to thereby enable one of ordinary skill in the art to utilize the invention in various forms and with various modifications as are suited to the particular use contemplated. All such modifications and variations are within the scope of the invention as determined by the appended claims when interpreted in accordance with the breadth to which they are fairly, legally, and equitably entitled.

1. A separator for use in an electrochemical cell that includes a cathode; an anode; and a non-aqueous electrolyte, the separator comprising:
a polymeric membrane placed between the cathode and anode, such that the separator separates the anode and a portion of the electrolyte from the cathode and the remaining portion of the electrolyte; wherein the polymeric membrane is permeable to the reversible flow of ions there through; and
an inorganic material applied to the polymeric membrane; the inorganic material being a mixture of a first inorganic particle and one or more second inorganic particles; wherein the inorganic material absorbs one or more of moisture, free transition metal ions, or hydrogen fluoride (HF) that become present in the electrochemical cell;
wherein the first inorganic particle comprises a lithium (Li)—exchanged zeolite and the one or more second inorganic particles are independently selected from the group consisting of silica, α-alumina, β-alumina, γ-alumina, magnesium oxide, titanium oxide, zirconium oxide, alumina silicate, calcium silicate, magnesium silicate, calcium carbonate, boehmite, kaolin, aluminum hydroxide, magnesium hydroxide, and perovskites.

2. The separator according to claim 1, wherein the weight ratio of the first inorganic particle to the one or more second inorganic particles is in the range of 0.1 wt. % to about 75.0 wt. % based on the overall weight of the inorganic material.

3. The separator according to claim 1, wherein the inorganic material as applied to the polymeric membrane is either dispersed within at least a portion of the separator or is in the form of a coating applied onto at least a portion of a surface of the separator.

4. The separator according to claim 1, wherein the first inorganic particle and the one or more second inorganic particles independently exhibit one or more of the following:
i) a morphology that is plate-like, cubic, spherical, or a combination thereof;
ii) an average particle size (D₅₀) that is in the range of 0.01 micrometers (μm) to about 2 micrometers (μm);
iii) a surface area that is in the range of about 10 m²/g to about 1000 m²/g; and
iv) a pore volume range of about 0.1 cc/g to about 2.0 cc/g.

5. (canceled)

6. (canceled)

7. (canceled)

8. The separator according to claim 1, wherein the first inorganic particle has a silica to alumina ratio that is in the range of about 1 to about 100.

9. The separator according to claim 1, wherein the first inorganic particle includes a zeolite framework selected from the group consisting of ABW, AFG, BEA, BHP, CAS, CHA, CHI, DAC, DOH, EDI, ESV, FAU, FER, FRA, GIS, GOO, GON, HEU, KFI, LAU, LTA, LTN, MEI, MER, MOR, MSO, NAT, NES, PAR, PAU, PHI, RHO, RTE, SOD, STI, TER, THO, VET, YUG, and ZSM.

10. The separator according to claim 9, wherein the zeolite framework includes a concentration of sodium (Na) that is lower than 10 wt. % and a concentration of lithium (Li) that is between 0.1 wt. % and 20 wt. % after the occurrence of lithium-ion exchange based on the overall weight of the first inorganic particle.

11. The separator according to claim 1, wherein the one or more second inorganic particles are selected as α-alumina, β-alumina, γ-alumina, boehmite, or aluminum hydroxide.

12. The separator according to claim 1, wherein the one or more second inorganic particles include a concentration of sodium (Na) being in the range of between 0.01 wt. % to 0.3 wt. % based on the overall weight of the inorganic particles.

13. The separator according to claim 1, wherein the first inorganic particle and the one or more second inorganic particles are present in the inorganic material as randomly dispersed particles or as core-shell composite particles in which one of the particles represent the core with the other particles being adhered to the core as the shell.

14. The separator according to claim 1, wherein the inorganic material further comprises an organic binder, such that the inorganic material accounts for about 10 wt. % to 99 wt. % of the overall weight of the coating.

15. The separator according to 14, wherein the organic binder comprises polyvinyl alcohol (PVA), polyethylene oxide (PEO), polyvinylpyrrolidone (PVP), polypropylene oxide (PPO), polyacrylic acid (PAA), carboxymethyl cellulose (CMC), sodium ammonium alginate (SAA), or a mixture thereof.

16. The separator according to claim 1, wherein the polymeric membrane comprises a polyolefin; poly(methyl methacrylate)-grafted, siloxane grafted polyethylene; polyvinylidene fluoride (PVDF) nanofiber webs; or blends thereof.

17. The separator according to claim 1, wherein the electrochemical cell is a secondary cell of a lithium-ion battery.

18. An electrochemical cell comprising:
a cathode as part of a positive electrode;
an anode as part of a negative electrode,
a non-aqueous electrolyte that supports the reversible flow of ions between the positive electrode and the negative electrode; and
a separator, the separator comprising:
a polymeric membrane placed between the positive electrode and negative electrode, such that the separator separates the anode and a portion of the electrolyte from the cathode and the remaining portion of the electrolyte; wherein the polymeric membrane is permeable to the reversible flow of ions there through; and
an inorganic material applied to the polymeric membrane; the inorganic material being a mixture of a first inorganic particle and one or more second inorganic particles; wherein the inorganic material absorbs one or more of moisture, free transition metal ions, or hydrogen fluoride (HF) that become present in the electrochemical cell;
wherein the first inorganic particle comprises a lithium (Li)—exchanged zeolite and the one or more second inorganic particles are independently selected from the group consisting of silica, α-alumina, β-alumina, γ-alumina, magnesium oxide, titanium oxide, zirconium oxide, alumina silicate, calcium silicate, magnesium silicate, calcium carbonate, boehmite, kaolin, aluminum hydroxide, magnesium hydroxide, and perovskites.

19. The cell according to claim 19, wherein the first inorganic particle and the one or more second inorganic particles exhibit
a morphology that is plate-like, cubic, spherical, or a combination thereof;
an average particle size (D₅₀) that is in the range of 0.01 micrometers (μm) to about 2 micrometers (μm);
a surface area that is in the range of about 10 m²/g to about 1000 m²/g; and
a pore volume in the range of 0.1-2.0 cc/g.

20. The cell according to claim 18, wherein the inorganic material as applied to the polymeric membrane is either dispersed within at least a portion of the separator or is in the form of a coating applied onto at least a portion of a surface of the separator;
wherein the weight ratio of the first inorganic particle to the one or more second inorganic particles is in the range of 0.1 wt. % to about 75.0 wt. % based on the overall weight of the inorganic material.

21. The cell according to claim 20 wherein the inorganic material further comprises an organic binder, such that the inorganic material accounts for about 10 wt. % to 99 wt. % of the overall weight of the inorganic material;
wherein the organic binder comprises polyvinyl alcohol (PVA), polyethylene oxide (PEO), polyvinylpyrrolidone (PVP), polypropylene oxide (PPO), polyacrylic acid (PAA), carboxymethyl cellulose (CMC), sodium ammonium alginate (SAA), or a mixture thereof.

22. The cell according to claim 18, wherein the first inorganic particle and the one or more second inorganic particles are present in the inorganic material as randomly dispersed particles or as core-shell composite particles in which one of the particles represent the core with the other particles being adhered to the core as the shell.

23. The cell according to claim 18, wherein the first inorganic particle includes a zeolite framework selected from the group consisting of ABW, AFG, BEA, BHP, CAS, CHA, CHI, DAC, DOH, EDI, ESV, FAU, FER, FRA, GIS, GOO, GON, HEU, KFI, LAU, LTA, LTN, MEI, MER, MOR, MSO, NAT, NES, PAR, PAU, PHI, RHO, RTE, SOD, STI, TER, THO, VET, YUG, and ZSM;
wherein the first inorganic particle has a silica to alumina ratio that is in the range of about 1 to about 100.

24. The cell according to claim 18, wherein the zeolite framework includes a concentration of sodium (Na) that is lower than 10 wt. % and a concentration of lithium (Li) that is between 0.1 wt. % and 20 wt. % after the occurrence of lithium-ion exchange based on the overall weight of the first inorganic particle;
wherein the one or more second inorganic particles include a concentration of sodium (Na) being in the range of between 0.01 wt. % to 0.3 wt. % based on the overall weight of the inorganic particles.

25. The cell according to claim 18, wherein the polymeric membrane comprises a polyolefin; poly(methyl methacrylate)-grafted, siloxane grafted polyethylene; polyvinylidene fluoride (PVDF) nanofiber webs; or blends thereof.

26. The cell according to claim 18, wherein the positive electrode comprises a lithium transition metal oxide or a lithium transition metal phosphate;
the negative electrode comprises graphite, a lithium titanium oxide, silicon metal, or lithium metal; and
the non-aqueous electrolyte is a solution of a lithium salt dispersed in an organic solution.

27. A lithium-ion secondary battery comprising:
one or more cells according to claim 18; and
a housing having an internal wall that encapsulates the one or more cells.
